(19) United States
(12) Patent Application Publication
(10) Pub. No.: US 2026/0081132 A1
(43) Pub. Date: Mar. 19, 2026

(54) APPARATUS AND METHOD FOR MANUFACTURING ELECTRODE PLATE OF SECONDARY BATTERY

(71) Applicant: SAMSUNG SDI CO., LTD., Yongin-si (KR)

(72) Inventors: Pilgoo JUN, Yongin-si (KR); Junsub LEE, Yongin-si (KR)

(21) Appl. No.: 19/226,501

(22) Filed: Jun. 3, 2025

(30) Foreign Application Priority Data
Sep. 13, 2024 (KR) 10-2024-0125945

(51) Int. Cl. H01M 4/04

(52) U.S. Cl. CPC H01M 4/0402; H01M 4/0435

(57) ABSTRACT

The present disclosure relates to an apparatus and method for manufacturing an electrode plate, forming a vertical profile of a coated region, and is directed to providing an apparatus and method for manufacturing an electrode plate, which are capable of vertically forming an edge of a coated region in a process of manufacturing an electrode plate. The present disclosure provides an apparatus for manufacturing an electrode plate of a secondary battery, which includes a shield attachment unit that attaches a shield to predetermined portion of a substrate of the electrode plate of the secondary battery, a coating unit that coats an electrode material to the substrate with the shield attached to the substrate, a shield removal unit that removes the shield such that the substrate has an uncoated region and a coated region, and a rolling unit that rolls the substrate.

### CROSS-REFERENCE TO RELATED APPLICATION

The present application claims priority to and the benefit under 35 U.S.C § 119(a)-(d) of Korean Patent Application No. 10-2024-0125945, filed in the Korean Intellectual Property Office on Sep. 13, 2024, the entire disclosure of which is incorporated herein by reference.

### BACKGROUND

### 1. Field

The present disclosure relates to an electrode plate of a secondary battery. More specifically, the present disclosure relates to an apparatus and method for manufacturing an electrode plate, which form a vertical profile of a coated region.

### 2. Description of Related Art

While primary batteries are not designed to be (re)charged, secondary (also known as rechargeable) batteries are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

The positive electrode or negative electrode plate can be manufactured through a coating process including coating one surface or both surfaces of an electrode substrate with an electrode material, a rolling process including pressing and stretching the substrate coated with the electrode material to make the substrate thin and flat, a slitting process including cutting the electrode plate coated in multiple rows in a longitudinal direction to be separated into individual electrode plates, and a notching process including cutting each separated electrode plate in a transverse direction, removing unnecessary portions, and forming tabs.

The coating process typically involves coating a substrate with an electrode material slurry using a slot die. A coated region is formed in a single row or multiple rows on the moving substrate, and some uncoated regions are exposed. An edge of the coated region in a lateral direction inevitably has an inclination due to surface tension during coating and drying, thereby affecting the charge/discharge capacity of a battery. In secondary batteries, vertical structure formation on the edge of the coated region in the lateral direction is one of important factors to consider.

The information disclosed in this Background section is for enhancement of understanding of the background of the present disclosure. The section may contain information that does not constitute related (or prior) art.

### SUMMARY

The present disclosure is directed to providing an apparatus and method for manufacturing an electrode plate, which are capable of vertically forming edges of a coated region in a process of manufacturing an electrode plate.

Embodiments of the present disclosure provide an apparatus for manufacturing an electrode plate of a secondary battery, which includes a shield attachment unit that attaches a shield to an uncoated region of a substrate of an electrode plate of a secondary battery, a coating unit that coats the substrate, to which the shield is attached, with an electrode material, a shield removal unit that removes the shield and leaves the coated electrode material, and a rolling unit that rolls the substrate from which the shield is removed.

In an embodiment, the apparatus may further include a primary drying unit that dries the substrate coated with the electrode material by the coating unit. The apparatus may further include a secondary drying unit that dries the substrate from which the shield is removed by the shield removal unit.

Embodiments of the present disclosure provide an apparatus including: a shield attachment unit configured to attach a shield to a predetermined portion of a substrate of an electrode plate of a secondary battery; a coating unit downstream of the shield attachment unit, the coating unit configured to coat an electrode material to the substrate with the shield attached to the substrate; a shield removal unit downstream of the coating unit, the shield removal unit configured to remove the shield such that the substrate has an uncoated region and a coated region; and a rolling unit downstream of the shield removal unit, the rolling unit configured to roll the substrate.

In an embodiment, the shield attachment unit includes the shield having an adhesive surface configured to be attached to the predetermined portion of the substrate.

In an embodiment, the apparatus further includes a primary drying unit downstream of the coating unit, the primary drying unit configured to dry the substrate.

In an embodiment, the apparatus further includes a secondary drying unit downstream of the shield removal unit, the secondary drying unit configured to dry the substrate.

In an embodiment, a drying temperature of the primary drying unit ranges from 60% to 80% of a drying temperature of the secondary drying unit.

In an embodiment, a drying time of the primary drying unit ranges from 8% to 15% of a total drying time of the primary drying unit and the secondary drying unit.

In an embodiment, the shield removal unit is configured to wind the shield separated from the substrate.

In an embodiment, the substrate has a plurality of the uncoated region continuously formed in the longitudinal direction, and wherein each of a plurality of the shield attachment unit is positioned at each of the plurality of the uncoated region continuously formed in the longitudinal direction.

Embodiments of the present disclosure provide an apparatus for manufacturing an electrode plate of a secondary battery, which includes a shield attachment unit that attaches a shield to an uncoated region of a substrate of an electrode plate of a secondary battery, a coating unit that coats the substrate, to which the shield is attached, with an electrode material, a primary drying unit that dries the substrate coated with the electrode material by the coating unit, a shield removal unit that removes the shield and leaves the coated electrode material, a secondary drying unit that dries the substrate from which the shield is removed by the shield removal unit, and a rolling unit that rolls the substrate from which the shield is removed.

Embodiments of the present disclosure provide a method of manufacturing an electrode plate of a secondary battery, which includes a shield attaching operation of attaching a shield to an uncoated region of a substrate of an electrode plate of a secondary battery, a coating operation of applying an electrode material to the substrate to which the shield is attached, a shield removing operation of removing the shield and leaving the coated electrode material, and a rolling operation of rolling the substrate from which the shield is removed.

Embodiments of the disclosure provide a method of manufacturing an electrode plate of a secondary battery, the method including: attaching a shield to a predetermined portion of a substrate of an electrode plate of a secondary battery; applying an electrode material to the substrate with the shield attached to the substrate; removing the shield such that the substrate has an uncoated region and a coated region; and rolling the substrate.

In an embodiment, in the attaching, the shield has an adhesive surface attached to the predetermined portion of the substrate.

In an embodiment, the method further includes after the applying, primarily drying the substrate.

In an embodiment, the method further includes after the removing, secondarily drying the substrate.

In an embodiment, a drying temperature of the primarily drying ranges from 60% to 80% of a drying temperature of the secondarily drying.

In an embodiment, a drying time of the primarily drying ranges from 8% to 15% of a total drying time of the primarily drying and the secondarily drying.

In an embodiment, the removing comprises winding the shield separated from the substrate.

In an embodiment, the substrate has a plurality of the uncoated region continuously formed in the longitudinal direction, and wherein the attaching comprises attaching the shield to each of the plurality of the uncoated region continuously formed in the longitudinal direction.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic view showing an electrode assembly of a secondary battery according to embodiments of the present disclosure;

FIG. 2 is a schematic view showing a pouch-type secondary battery according to embodiments of the present disclosure;

FIG. 3 is a cross-sectional view of a cylindrical secondary battery according to embodiments of the present disclosure;

FIG. 4 shows an internal configuration of a prismatic secondary battery according to embodiments of the present disclosure;

FIG. 5 shows a process of manufacturing an electrode plate of the electrode assembly shown in FIG. 1 according to embodiments of the present disclosure;

FIG. 6 shows a single-row coating electrode plate according to embodiments of the present disclosure;

FIG. 7 shows a multi-row coating electrode plate according to embodiments of the present disclosure;

FIG. 8 is a cross-sectional view along line A-A′ in FIG. 6 and shows a cross-sectional structure of a coated region and an uncoated region formed by a coating apparatus according to embodiments of the present disclosure;

FIG. 9 is a cross-sectional view along line B-B′ in FIG. 7 and shows a cross-sectional structure of first to third coated regions and the uncoated region formed by the coating apparatus according to embodiments of the present disclosure;

FIG. 10 shows a method of forming vertical walls on edges of a coated region in a width direction according to embodiments of the present disclosure;

FIG. 11 shows a method of forming vertical walls on edges of a coated region in a width direction according to embodiments of the present disclosure;

FIG. 12 shows a method of forming vertical walls on edges of a coated region in a width direction according to embodiments of the present disclosure;

FIG. 13 shows an apparatus and method for manufacturing an electrode plate of a secondary battery according to embodiments of the present disclosure;

FIG. 14 shows a secondary battery module in which secondary batteries are arranged that may be manufactured according to embodiments of the present disclosure;

FIG. 15 shows a secondary battery pack including the secondary battery module of FIG. 14 according to embodiments of the present disclosure; and

FIG. 16 is shows a vehicle including the secondary battery pack of FIG. 15 according to embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

The embodiments described herein can be explained with reference to cross-sectional views and/or plan views as example views of the present disclosure. In the figures, dimensions of the various elements, layers, etc. may be exaggerated for clarity of illustration. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof. The same reference numerals designate the same elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

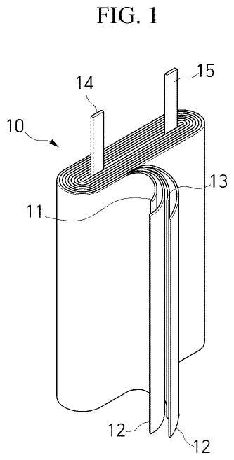

FIG. 1 is a schematic view showing an electrode assembly of a secondary battery according to embodiments of the present disclosure.

An electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to the longitudinal direction of a case. In some embodiments, the electrode assembly 10 may be a stacked type. The shape of the electrode assembly 10 is not limited in the present disclosure. The electrode assembly 10 may be a Z-stack electrode assembly in which a positive electrode plate and a negative electrode plate are inserted into both sides (e.g., opposite sides) of a separator, which is then bent (or folded) into a Z-stack. One or more electrode assemblies may be stacked (e.g., arranged) such that long sides of the electrode assemblies are adjacent to each other and accommodated in a case. The number of electrode assemblies in a case is not limited in the present disclosure. The first electrode plate 11 of the electrode assembly may be configured as a negative electrode and the second electrode plate 13 may be configured as a positive electrode, and vice versa.

The first electrode plate 11 may be formed by applying (e.g., coating or depositing) a first electrode active material, such as graphite or carbon, onto a first electrode substrate formed of a metal foil including copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to or protrude from one side of the electrode assembly 10. In some embodiments, the first electrode tab 14 may protrude to or protrude from one side of the electrode assembly 10 farther than or beyond the separator 12 without being separately cut.

The second electrode plate 13 may be formed by applying (e.g., coating or depositing) a second electrode active material including a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to or protrude from the other side (e.g., the opposite side) of the electrode assembly 10 when the second electrode plate 13 is manufactured. In some embodiments, the second electrode plate 13 may protrude to or protrude from the other side of the electrode assembly farther than or beyond the separator 12 without being separately cut.

The separator 12 prevents a short-circuit between the first electrode plate 11 and the second electrode plate 13 while allowing migration of lithium ions therebetween. The separator 12 may include a polyethylene film, a polypropylene film, a polyethylene-polypropylene film, or the like.

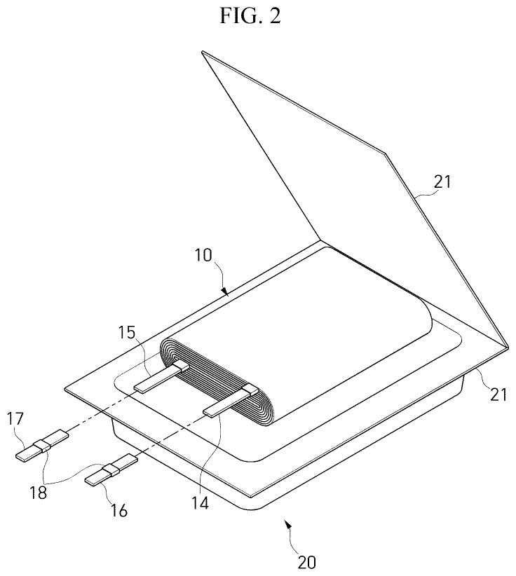

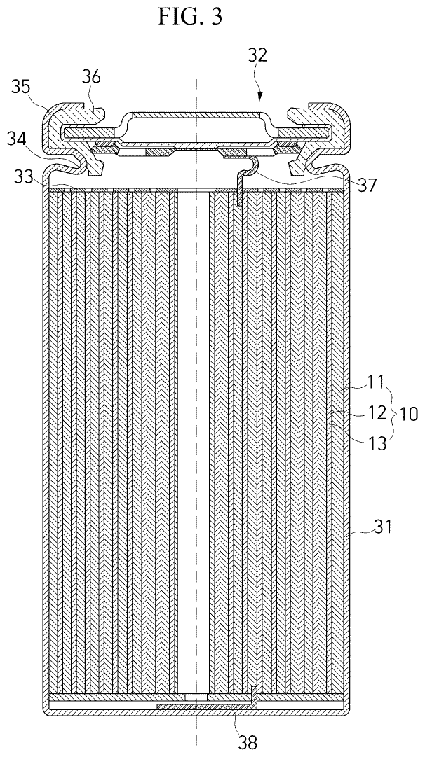

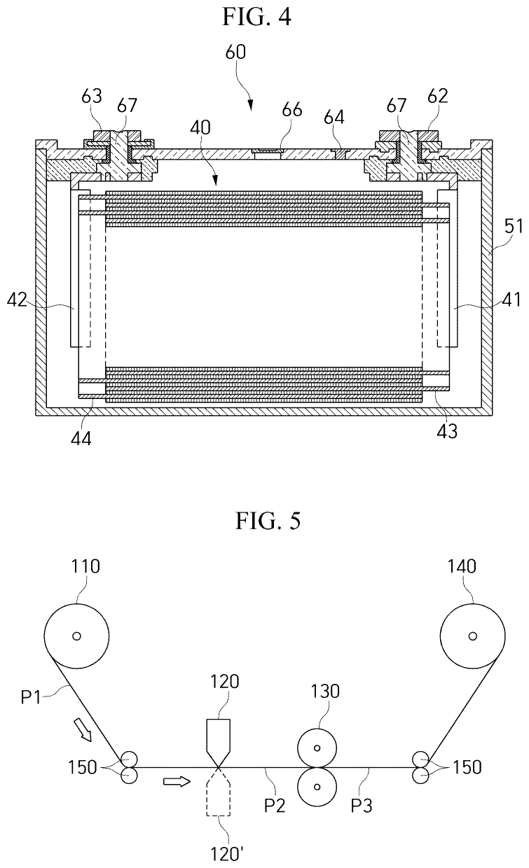

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

FIG. 2 is a schematic view showing a pouch-type secondary battery according to embodiments of the present disclosure.

The pouch-type secondary battery includes an electrode assembly 10 and a pouch 20 that accommodates the electrode assembly 10.

The electrode assembly 10 can be substantially the same as that shown in FIG. 1. The first electrode tab 14 and the second electrode tab 15 of the electrode assembly 10 may be electrically connected to respective external first terminal lead 16 and second terminal lead 17 by welding. Each of the first terminal lead 16 and the second terminal lead 17 may be attached with a tab film 18 for insulation from the pouch 20.

The pouch 20 may be sealed by having sealing parts 21 at the edges thereof come into contact with each other while accommodating the electrode assembly 10 therein. The sealing may be achieved with the tab film 18 interposed between the sealing parts 21. The sealing parts 21 of the pouch 20 may each include a thermal fusion material that generally has weak adhesion to metal. Thus, the sealing parts 21 may be fused to the pouch 20 by interposing the thin tab film 18 between the sealing parts 21.

FIG. 3 is a cross-sectional view of a cylindrical secondary battery according to embodiments of the present disclosure. A secondary battery may include an electrode assembly 10, a case 31 accommodating the electrode assembly 10 and the electrolyte, a cap assembly 32 coupled to an opening of the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 31, forms the external appearance of the secondary battery. The case 31 may have a substantially cylindrical body portion 12 and a bottom portion connected to one side (e.g., to one end) of the body portion. A beading part 34 (e.g., a bead) recessed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of the gasket and the cap assembly 31. The crimping part 35 may firmly fix the cap assembly 32 by pressing the edge of the case 31 against the gasket 36. The case 31 may include iron plated with nickel.

The cap assembly 32 may be fixed to the inside of the crimping part 35 via a gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 shows an internal configuration of a prismatic secondary battery according to embodiments of the present disclosure. The prismatic secondary battery may include an electrode assembly 40, a first current collector, a first terminal 62, a second current collector 42, a second terminal 63, and a cap plate 61.

The electrode assembly 40 may be formed into s wound-type or stacked-type by winding or stacking a first electrode plate, a separator, and a second electrode plate formed in a plate or a sheet shape as shown in FIG. 1. However, the types of the electrode assembly 40 is not limited in the present disclosure.

The electrode assembly 40 may be a Z-stack electrode assembly in which a positive electrode plate and a negative electrode plate are inserted into both sides of a separator, which is then bent into a Z-stack. In an embodiment, one or more electrode assemblies may be stacked such that long sides of the electrode assemblies are adjacent to each other and accommodated in the case. The number of electrode assemblies in the case is not limited in the present disclosure. The first electrode plate of the electrode assembly may be configured as a negative electrode and the second electrode plate may be configured as a positive electrode, and vice versa.

A first electrode tab 43 of the first electrode plate and a second electrode tab 44 of the second electrode plate extend from both ends of the electrode assembly 40.

In some embodiments, the electrode assembly 40 is accommodated in the case 10 along with an electrolyte.

In the electrode assembly 40, the first current collector 41 and the second current collector 42 may be welded and connected to the first electrode tab 43 extending from the first electrode plate and the second electrode tab 44 extending from the second electrode plate, respectively. In some embodiments in which the first electrode tab 43 and the second electrode tab 44 are located at the top of the electrode assembly 40, the first and second current collectors can be located at the top of the electrode assembly 40.

The first current collector 41 and the second current collector 42 are connected to the first terminal 62 and the second terminal 63, respectively, via connection members 67. In some embodiments, the connection members 67 may each have an outer peripheral surface that is threaded, and may be fastened to the first terminal 62 and the second terminal 63 by screwing. However, the present disclosure is not limited thereto. In an embodiment, the connection members 67 may also be coupled to the first terminal 62 and the second terminal 63 by riveting or welding.

FIG. 5 is a schematic diagram showing an apparatus and method for manufacturing a secondary battery electrode plate (the first electrode plate 11 or the second electrode plate 13 shown in FIG. 1) according to embodiments of the present disclosure.

A supply roll 110 is a roll on which a substrate P1 for an electrode plate is wound. When an apparatus for manufacturing electrode plates is used to manufacture a positive electrode plate, the substrate P1 may be a metal foil containing aluminum (Al). In an embodiment, when the apparatus for manufacturing electrode plates is used to manufacture a negative electrode plate, the substrate P1 may be a metal foil containing copper (Cu) or nickel (Ni).

A transfer roller 150 may be an idle roller that guides the substrate P1 unwounded from the supply roll 110, or a drive roller that applies a pulling force to allow the substrate P1 to be unwounded from the supply roll 110. FIG. 5 shows a total of four transfer rollers 150, but the number and positions of transfer rollers may be varies as needed.

A coating unit 120 forms a coating layer by coating the substrate P1 with a pre-prepared electrode material slurry. The coating slurry mixture includes an active material, and if manufacturing a positive electrode plate, the slurry mixture may include an active material including a lithium transition metal oxide, a binder, and a volatile solvent. If manufacturing a negative electrode plate, a slurry mixture may also be prepared with an active material, a binder, and a solvent.

It is possible to simultaneously coat both surfaces, namely the upper and lower surfaces, of the substrate P1 by adding a second coating unit 120′, having the same configuration as the coating unit 120 shown in FIG. 5, to the lower surface of the substrate P1.

A press unit 130, i.e., a rolling or calendaring unit, uses rollers to compresses an electrode plate P2 coated with the slurry (mixture) by the coating unit 120 in order to produce a high-capacity and high-density secondary battery.

A winding roll 140 is a roll that winds and accommodates an electrode plate P3 coated and rolled by the coating unit 120 and the press unit 130.

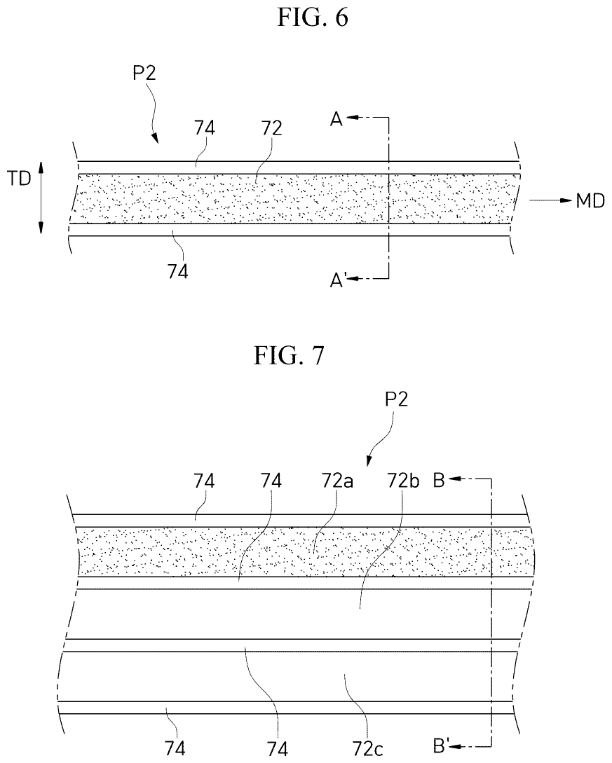

FIG. 6 shows a substrate (e.g., P2 in FIG. 5) coated with an electrode material according to embodiments of the present disclosure. The coated substrate has a coated region 72 coated with a mixture (electrode material mixture) and an uncoated region (uncoated portion) 74 that remains as the substrate that is not coated. For reference, a width direction of the electrode plate is referred to as a transverse direction TD and a longitudinal direction in which the electrode plate moves is referred to as a machine direction MD. Coating may be single-row coating (see FIG. 6) performed in one row (or also called a lane) in the width direction TD of the substrate, and multi-row coating (see FIG. 7) simultaneously performed in multiple rows of coated regions. Coating may be performed using a slot die.

FIG. 7 shows a substrate in which a coated region is formed in multiple rows by a multi-coating apparatus and shows a first-row coated region 72a, a second-row coated region 72b, and a third-row coated region 72c that have an uncoated region (uncoated region) 74 as a boundary are positioned in parallel in the transverse direction TD according to embodiments of the present disclosure. The uncoated region 74 may be present between rows and present at an outer portion. The multi-coated electrode plate may be cut in the machine direction MD in a subsequent slitting process to be separated into the row coated regions 72a, 72b, and 72c.

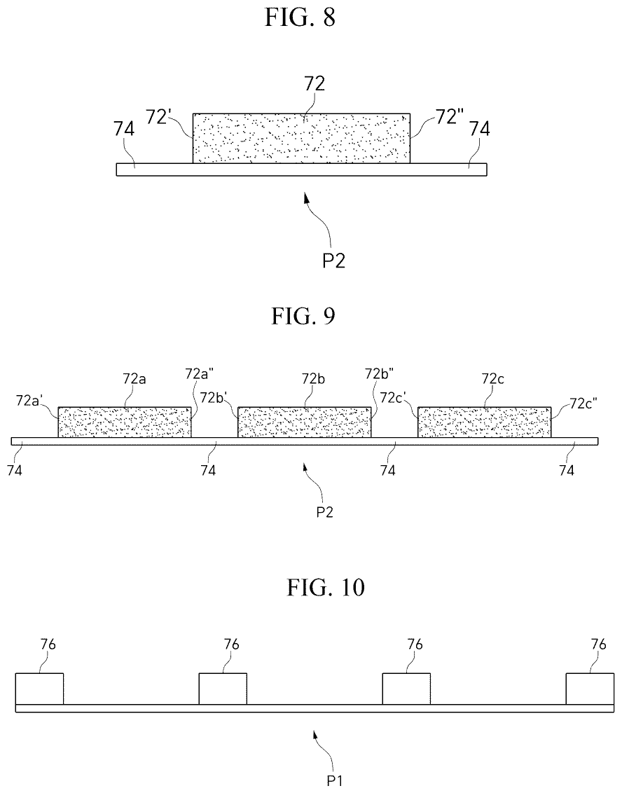

FIG. 8 is a cross-sectional view along line A-A′ in FIG. 6 and shows a cross-sectional structure of the coated region 72 and the uncoated region 74 formed by a coating apparatus according to embodiments of the present disclosure. The coated region 72 includes a first vertical wall 72′ and a second vertical wall 72″ that are perpendicular to the substrate P2 at both edges thereof.

FIG. 9 is a cross-sectional view along line B-B′ in FIG. 7 and shows a cross-sectional structure of the first to third coated regions 72a, 72b, and 72c and the uncoated region 74 formed by the coating apparatus according to embodiments of the present disclosure. It can be seen that edges at both sides of the row coated regions 72a, 72b, and 72c include first vertical walls 72a′, 72b′, and 72c′ and second vertical walls 72a″, 72b″, and 72c″ that are perpendicular to the substrate P2.

In general, edges of the coated region in the width direction are inevitably coated to have an inclination during coating, and furthermore, the inclination may become steep due to the surface tension of the electrode material through a drying process. Such steeply inclined side walls of the edges of the coated region in the width direction may have a reduced effective area and thickness of the coated region, thereby reducing the energy density of the battery.

FIGS. 10 to 12 show a method of forming vertical walls on edges of a coated region in a width direction according to embodiments of the present disclosure. FIGS. 10 to 12 show multi-row coating.

First, as shown in FIG. 10, a shield 76 is attached to the uncoated region (i.e., a region between the coated regions 72a, 72b, and 72c and the uncoated region 74 shown in FIG. 7) not coated on a substrate P1 of the electrode plate to be coated. The shield 76 is preferably formed of a material that is easily removed later. In an embodiment, the shield 76 may be a masking tape having an adhesive surface on one surface thereof.

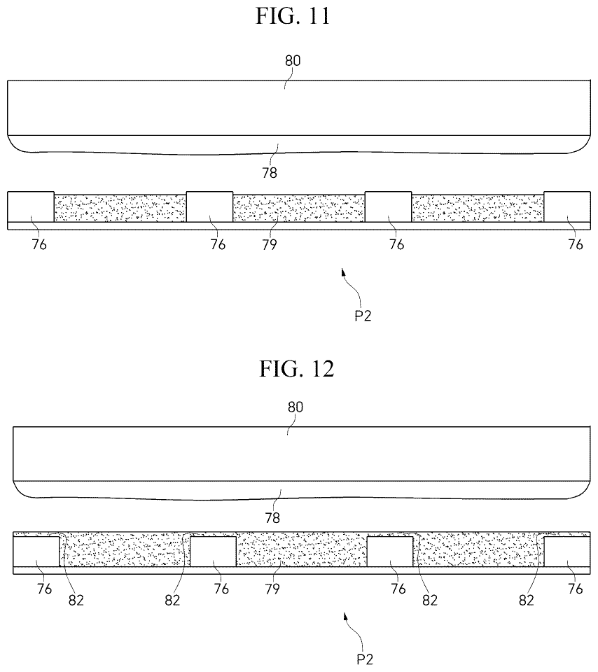

Next, as shown in FIG. 11 or FIG. 12, the substrate P2 on which a coating layer 79 is formed is manufactured by applying an electrode material 78 to the substrate to which the shield 76 is attached. Thereafter, when the coating layer 79 is dried and the shield 76 is removed, the row coated regions 72a, 72b, and 72c having the first vertical walls 72a′, 72b′, and 72c′ and the second vertical walls 72a″, 72b″, and 72c″ of which edges are perpendicular to the substrate P2 as shown in FIG. 8 or FIG. 9 may be obtained.

The electrode material 78 may be a mixed slurry of an active material, a binder, and an additive (the coating referred to as a wet method). The substrate may be coated with the electrode material 78 in the form of slurry by a slot die 80, but the present disclosure is not limited thereto. In an embodiment, the electrode material 78 may be a mixed powder of an active material, a binder, and an additive. The slot die 80 may be replaced with a powder spray (the coating referred to as a dry method).

In conventional multi-row electrode coating, the slot die 80 needs to use a relatively wide slot die for multi-row coating in which a plurality of slurry outlets are arranged. In contrast, the present disclosure provides the entire surface to which the shield 76 is attached being coated with the slurry, the slot die for single-row coating may be used instead of the wide slot die for multi-row coating. The wide slot die for multi-row coating is costly than the slot die for single-row coating, and embodiments of the present disclosure may reduce manufacturing costs.

When the entire substrate surface including the shield 76 attached to the substrate is coated with the electrode material 78, as shown in FIG. 11, the coating layer 79 may be formed to have a thickness equal to or slightly lower than a height of the shield 76, or as shown in FIG. 12, the coating layer 79 including a coating layer 82 covering the surface of the shield 76, which is thicker than the height of the shield 76 may be formed. In the case of FIG. 12, when the shield 76 is separated, the coating layer 82 covering the surface of the shield 76 may be separated together, causing upper portions of side edges of the row coated regions 72a, 72b, and 72c (see FIG. 9) not to form a completely vertical wall. However, this can be overcome by pressing the coated regions 72a, 72b, and 72c via a rolling mill in a subsequent rolling process.

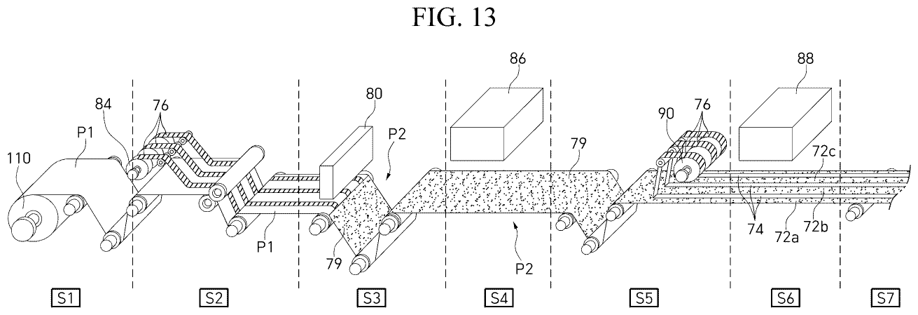

FIG. 13 shows an apparatus and method for manufacturing an electrode plate of a secondary battery according to embodiments of the present disclosure.

Operation S1 denotes a substrate supplying operation, operation S2 denotes a shield attaching operation, operation S3 denotes an electrode material coating operation, operation S4 denotes a primary drying operation, operation S5 denotes a shield removing operation, operation S6 denotes a secondary drying operation, and operation S7 denotes a substrate transporting operation to a subsequent process.

In the substrate supplying operation S1, the substrate P1 may be supplied by being unwound from a supply roll 110 as described in FIG. 5. Although FIG. 13 shows the substrate P1 as a substrate for a multi-coating range, the present disclosure is not limited thereto.

In the shield attaching operation S2, the shield 76 may be attached to each uncoated region of the substrate P1 such as the uncoated regions 74 shown in FIG. 7. A shield attachment unit may include a roll 84 around which the shield 76 is wound. The shield 76 may be a tape having an adhesive surface formed thereon. In some embodiments, a release paper may be attached to the adhesive surface of the shield 76, and another roll (not shown) that peels off and removes the release paper when the shield 76 is unwound from the roll 84 so as to be attached to the substrate P1 may be included in the shield attachment unit. In some embodiments, the shield 76 may be wound directly around the roll 84 without the release paper attached to the adhesive surface.

In the electrode material coating operation S3, a coating unit coats the substrate, to which the shield 76 is attached, with the electrode material 78 (see FIGS. 11 and 12) to manufacture the substrate P2 on which the coating layer 79 is formed. In some embodiments, the coating unit may be the slot die 80 that discharges a mixture slurry. In some embodiments, the coating unit may be a powder sprayer that sprays a mixture powder. Even in multi-coating as shown in FIG. 13, the slot die 80 may use a slot die for single-row coating that has a single slurry outlet, thereby saving manufacturing costs.

The primary drying operation S4 and/or the secondary drying operation S6 may be selectively applied according to the wet method or the dry method depending on the shield 76 attached in operation S2 and/or the electrode material applied in operation S3.

In operation S4, a primary drying unit 86 may be performed before the shield 76 is removed from the substrate P2 on which the electrode material coating layer 79 is formed by the coating unit. In a case in which an adhesive tape is used as the shield 76, the shield 76 can be easily removed by the primary drying.

In the shield removing operation S5, the shield removal unit removes the shield 76 from the electrode material coating layer 79 and leaves the coating layer intact. The shield 76 may be removed to obtain the coated region of the vertical side wall as shown in FIG. 9.

In some embodiments, the shield removal unit may include a roll 90 that separates the shield 76 from the substrate P2 and winds the shield 76.

In the secondary drying operation S6, a secondary drying unit 88 may dry the substrate from which the shield is removed by the shield removal unit.

A drying temperature and drying time of the primary drying unit 86 may be less than a drying temperature and drying time of the secondary drying unit 88. In some embodiments, the drying temperature of the primary drying unit 86 may range from about 60% to 80% of the drying temperature of the secondary drying unit 88, and preferably, may be about 70%. In some embodiments, the drying time of the primary drying unit 86 may range from about 8% to 15% of the total drying time of the primary drying unit 86 and the secondary drying unit 88, and preferably, may be about 10%.

Operation S7 denotes the substrate transport operation to a subsequent process. Here, the subsequent process may be a rolling process of roll-pressing the substrate from which the shield 76 is removed but is not limited thereto. The substrate may not be transported to the subsequent process, but the coated substrate may be wound around a reel and stored.

The positive electrode active material may include a compound capable of reversibly intercalating/deintercalating lithium (e.g., a lithiated intercalation compound). In some embodiments, at least one of a composite oxide of lithium and a metal including cobalt, manganese, nickel, or combinations thereof.

The composite oxide may include a lithium transition metal composite oxide such as a lithium nickel-based oxide, a lithium cobalt-based oxide, a lithium manganese-based oxide, a lithium iron phosphate-based compound, a cobalt-free nickel-manganese-based oxide, or a combination thereof.

In some embodiments, the composite oxide may include a compound represented by any one of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8) where A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a substrate and a positive electrode active material layer positioned on the substrate. The positive electrode active material layer may include a positive electrode active material and may further include a binder and/or a conductive material.

The positive electrode active material may include about 90 wt % to about 99.5 wt % on the basis of 100 wt % of the positive electrode active material layer, and about 0.5 wt % to about 5 wt % of a binder, and about 0 wt % to about 5 wt % of a conductive material on the basis of 100 wt % of the positive electrode active material layer.

The substrate may include aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may include a carbon-based negative electrode active material including crystalline carbon, amorphous carbon, or a combination thereof. In an embodiment, the crystalline carbon may include graphite, such as natural graphite or artificial graphite, and the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may include silicon, a silicon-carbon composite, SiOx (0<x<2), a Si-based alloy, or a combination thereof.

The silicon-carbon composite may include a composite of silicon and/or amorphous carbon. According to an embodiment, the silicon-carbon composite may exist in the form of a silicon particle and amorphous carbon coated on the surface of the silicon particle.

The silicon-carbon composite may further include crystalline carbon. In an embodiment, the silicon-carbon composite may include a core including crystalline carbon and silicon particle and an amorphous carbon coating layer on the surface of the core.

A negative electrode for a lithium secondary battery may include a substrate and a negative electrode active material layer positioned on the substrate. The negative electrode active material layer may include a negative electrode active material and may further include a binder and/or a conductive material.

The negative electrode active material layer may include about 90 wt % to about 99 wt % of a negative electrode active material, about 0.5 wt % to about 5 wt % of a binder, and about 0 wt % to about 5 wt % of a conductive material on the basis of 100 wt % of the negative electrode active material layer.

The binder may include a non-aqueous binder, an aqueous binder, a dry binder, or a combination thereof. When an aqueous binder is used as the negative electrode binder, a cellulose-based compound capable of enhancing viscosity may be further included.

The negative electrode substrate may include copper foil, nickel foil, stainless steel foil, titanium foil, nickel foam, copper foam, conductive metal-coated polymer substrate, or combinations thereof.

The electrolyte for a lithium secondary battery may include a non-aqueous organic solvent and/or a lithium salt.

The non-aqueous organic solvent is configured to serve as a medium through which ions involved in the electrochemical reaction of the battery can migrate.

The non-aqueous organic solvent may include a carbonate-based, an ester-based, an ether-based, a ketone-based, an alcohol-based solvent, an aprotic solvent or combinations thereof.

In an embodiment, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). The separator may include polyethylene, polypropylene, polyvinylidene fluoride, or a multilayer film including two or more layers thereof.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles including Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof but is not limited thereto.

The organic material and the inorganic material may be combined into one coating layer or may be in the form of a coating layer including (or containing) an organic material and a coating layer including (or containing) an inorganic material where one coating layer is stacked onto the other.

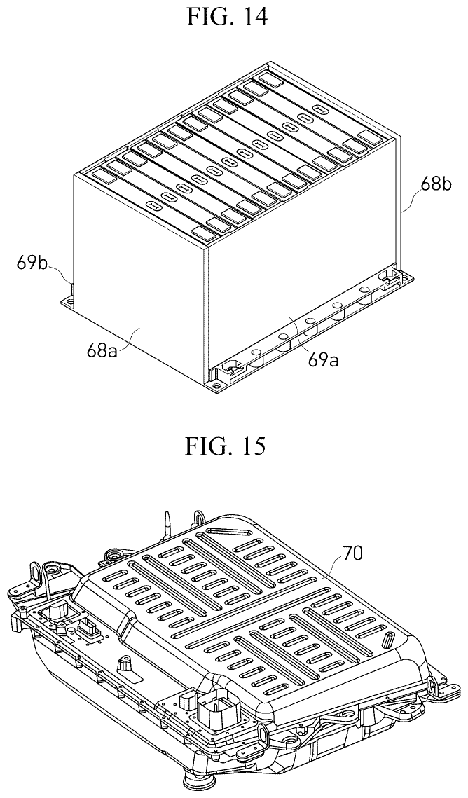

FIG. 14 shows a secondary battery module in which secondary batteries are arranged that may be manufactured according to the embodiments of the present disclosure. Pursuant to the high capacity of secondary batteries for driving electric vehicles or the like, a secondary battery module is manufactured by arranging and connecting a plurality of secondary battery cells in a transverse direction and/or a longitudinal direction. The plurality of secondary batteries may be arranged in a space defined by a pair of facing end plates 68a and 68b and a pair of facing side plates 69a and 69b. The secondary battery may have an arrangement direction and number to obtain the desired voltage and current specifications.

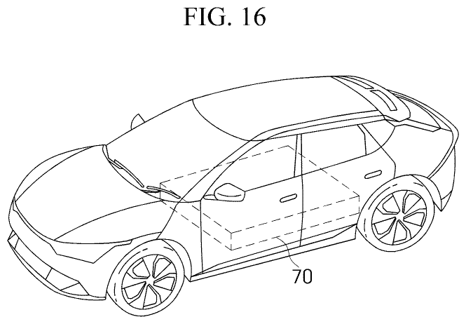

FIG. 15 shows a secondary battery pack 70 formed to apply the secondary battery module shown in FIG. 14 to actual products (e.g., vehicles) according to embodiments of the present disclosure. A secondary battery pack can be manufactured by embedding a plurality of secondary battery modules in a pack housing designed to be mounted on an actual product. The pack housing may include fastening parts and electrical outlets necessary for mounting on a product. For convenience of illustration, components including a bus bar, a cooling unit, external terminals for electrically connecting batteries, etc., are not shown.

The secondary battery pack may be mounted on (or in) a vehicle. The vehicle may be an electric vehicle, a hybrid vehicle, or a plug-in hybrid vehicle. The vehicle may be a four-wheeled vehicle or a two-wheeled vehicle but is not limited thereto.

FIG. 16 shows a vehicle that includes the battery pack shown in FIG. 15 according to embodiments of the present disclosure. FIG. 16 shows a vehicle that includes the battery pack 70 on the lower body thereof. The vehicle may operate by (e.g., may be powered by) receiving power from the battery pack 70.

According to the present disclosure, edges of a coated region can be vertically formed in a process of manufacturing an electrode plate, thereby increasing an effective volume (area, thickness, or the like) of the coated region and increasing an energy density of a battery. In addition, since an expensive wide slot die for multi-row coating does not need to be used during manufacturing of a multi-row coating electrode plate, it is possible to greatly save manufacturing costs.

Although the present disclosure has been described above with respect to embodiments thereof, the present disclosure is not limited thereto. Various modifications and variations can be made thereto by those skilled in the art within the spirit of the present disclosure.

What is claimed is:

1. An apparatus comprising:
a shield attachment unit configured to attach a shield to a predetermined portion of a substrate of an electrode plate of a secondary battery;
a coating unit downstream of the shield attachment unit, the coating unit configured to coat an electrode material to the substrate with the shield attached to the substrate;
a shield removal unit downstream of the coating unit, the shield removal unit configured to remove the shield such that the substrate has an uncoated region and a coated region; and
a rolling unit downstream of the shield removal unit, the rolling unit configured to roll the substrate.

2. The apparatus as claimed in claim 1, wherein the shield attachment unit comprises the shield having an adhesive surface configured to be attached to the predetermined portion of the substrate.

3. The apparatus as claimed in claim 1, further comprising a primary drying unit downstream of the coating unit, the primary drying unit configured to dry the substrate.

4. The apparatus as claimed in claim 3, further comprising a secondary drying unit downstream of the shield removal unit, the secondary drying unit configured to dry the substrate.

5. The apparatus as claimed in claim 4, wherein a drying temperature of the primary drying unit ranges from 60% to 80% of a drying temperature of the secondary drying unit.

6. The apparatus as claimed in claim 4, wherein a drying time of the primary drying unit ranges from 8% to 15% of a total drying time of the primary drying unit and the secondary drying unit.

7. The apparatus as claimed in claim 1, wherein the shield removal unit is configured to wind the shield separated from the substrate.

8. The apparatus as claimed in claim 1, wherein the substrate has a plurality of the uncoated region continuously formed in the longitudinal direction, and
wherein each of a plurality of the shield attachment unit is positioned at each of the plurality of the uncoated region continuously formed in the longitudinal direction.

9. The apparatus as claimed in claim 4, wherein the shield attachment unit comprises the shield having an adhesive surface configured to be attached to the predetermined portion of the substrate.

10. The apparatus as claimed in claim 4, wherein the shield removal unit is configured to wind the shield separated from the substrate.

11. The apparatus as claimed in claim 4, wherein the substrate has a plurality of the uncoated region continuously formed in the longitudinal direction, and
wherein each of a plurality of the shield attachment unit is positioned at each of the plurality of the uncoated region continuously formed in the longitudinal direction.

12. A method of manufacturing an electrode plate of a secondary battery, the method comprising:
attaching a shield to a predetermined portion of a substrate of an electrode plate of a secondary battery;
applying an electrode material to the substrate with the shield attached to the substrate;
removing the shield such that the substrate has an uncoated region and a coated region; and
rolling the substrate.

13. The method as claimed in claim 12, wherein in the attaching, the shield has an adhesive surface attached to the predetermined portion of the substrate.

14. The method as claimed in claim 12, further comprising after the applying, primarily drying the substrate.

15. The method as claimed in claim 14, further comprising after the removing, secondarily drying the substrate.

16. The method as claimed in claim 15, wherein a drying temperature of the primarily drying ranges from 60% to 80% of a drying temperature of the secondarily drying.

17. The method as claimed in claim 15, wherein a drying time of the primarily drying ranges from 8% to 15% of a total drying time of the primarily drying and the secondarily drying.

18. The method as claimed in claim 12, wherein the removing comprises winding the shield separated from the substrate.

19. The method as claimed in claim 12, wherein the substrate has a plurality of the uncoated region continuously formed in the longitudinal direction, and
wherein the attaching comprises attaching the shield to each of the plurality of the uncoated region continuously formed in the longitudinal direction.
